(19) United States
(12) Patent Application Publication
(10) Pub. No.: US 2014/0358528 A1
(43) Pub. Date: Dec. 4, 2014

(54) Electronic Apparatus, Method for Outputting Data, and Computer Program Product

(71) Applicants: KABUSHIKI KAISHA TOSHIBA, Tokyo (JP); TOSHIBA LIFESTYLE PRODUCTS & SERVICES CORPORATION, Tokyo (JP)

(72) Inventor: Shinichiro Manabe, Akishima-shi (JP)

(21) Appl. No.: 14/460,165

(22) Filed: Aug. 14, 2014

Related U.S. Application Data
(63) Continuation of application No. PCT/JP2013/057093, filed on Mar. 13, 2013.

(51) Int. Cl. G10L 25/27; G10L 21/10; G10L 15/00; H04J 1/02

(52) U.S. Cl. CPC G10L 25/27; H04J 1/02; G10L 21/10; G10L 15/005
USPC 704/205

(57) ABSTRACT

According to one embodiment, an electronic apparatus includes a receiver and a processor. The receiver is configured to receive a signal of multiplexed sound comprising data of main sound and sub data. The data of main sound is multiplexed in an audible frequency band. The sub data is multiplexed in a non-audible frequency band. The multiplexed sound is output by an audio speaker of another device and is collected by a microphone of the electronic apparatus. The processor is configured to acquire the sub data from the signal of the multiplexed sound, and to output the sub data.

### CROSS-REFERENCE TO RELATED APPLICATIONS

This application is a continuation of PCT international application Ser. No. PCT/JP2013/057093 filed on Mar. 13, 2013 which designates the United States, incorporated herein by reference.

### FIELD

Embodiments described herein relate generally to an electronic apparatus, a method for outputting data, and a computer program product.

### BACKGROUND

Conventionally, there has been known a technique such that audio signals obtained by multiplexing sounds of a plurality of languages are transmitted through electromagnetic waves and a user receives the electromagnetic waves by using a receiver to reproduce audio signals of a language desired thereby.

However, in such a conventional technique, it has been desired that information such as sounds other than main sound is transmitted and utilized without using signals at an electromagnetic wave band and without disturbing a third person.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary view illustrating a configuration of an information processing system according to a first embodiment;

FIG. 2 is an exemplary view illustrating an example of multiplexed sound in the first embodiment;

FIG. 3 is an exemplary flowchart illustrating procedures of sub data output processing in the first embodiment;

FIG. 4 is an exemplary view illustrating one example of a viewing-and-listening confirmation screen for sounds and characters other than main sound in the first embodiment;

FIG. 5 is an exemplary view illustrating one example of a language type selection screen in the first embodiment;

FIG. 6 is an exemplary flowchart illustrating procedures of sub data output processing according to a second embodiment;

FIG. 7 is an exemplary view illustrating a configuration of an information processing system according to a third embodiment;

FIG. 8 is an exemplary view illustrating an example of multiplexed sound in the third embodiment;

FIG. 9 is an exemplary flowchart illustrating procedures of sub data output processing in the third embodiment;

FIG. 10 is an exemplary view illustrating one example of a multiplexed sound structure according to a modification of the third embodiment;

FIG. 11 is an exemplary view illustrating a configuration of an information processing system according to a fourth embodiment;

FIG. 12 is an exemplary view illustrating an example of multiplexed sound in the fourth embodiment; and

FIG. 13 is an exemplary flowchart illustrating procedures of sub data output processing in the fourth embodiment.

### DETAILED DESCRIPTION

In general, according to one embodiment, an electronic apparatus comprises a receiver and a processor. The receiver is configured to receive a signal of multiplexed sound comprising data of main sound and sub data. The data of main sound is multiplexed in an audible frequency band. The sub data is multiplexed in a non-audible frequency band. The multiplexed sound is output by an audio speaker of another device and is collected by a microphone of the electronic apparatus. The processor is configured to acquire the sub data from the signal of the multiplexed sound, and to output the sub data.

Hereinafter, with reference to attached drawings, an information processing device, a method for outputting data, and a computer program according to embodiments are explained in detail. Here, the information processing device in the embodiments described below can be applied to a computer such as a notebook-type personal computer (PC), a handheld terminal such as a smart phone, a tablet terminal, or the like. However, a device to which the information processing device can be applied is not limited to these devices.

### First Embodiment

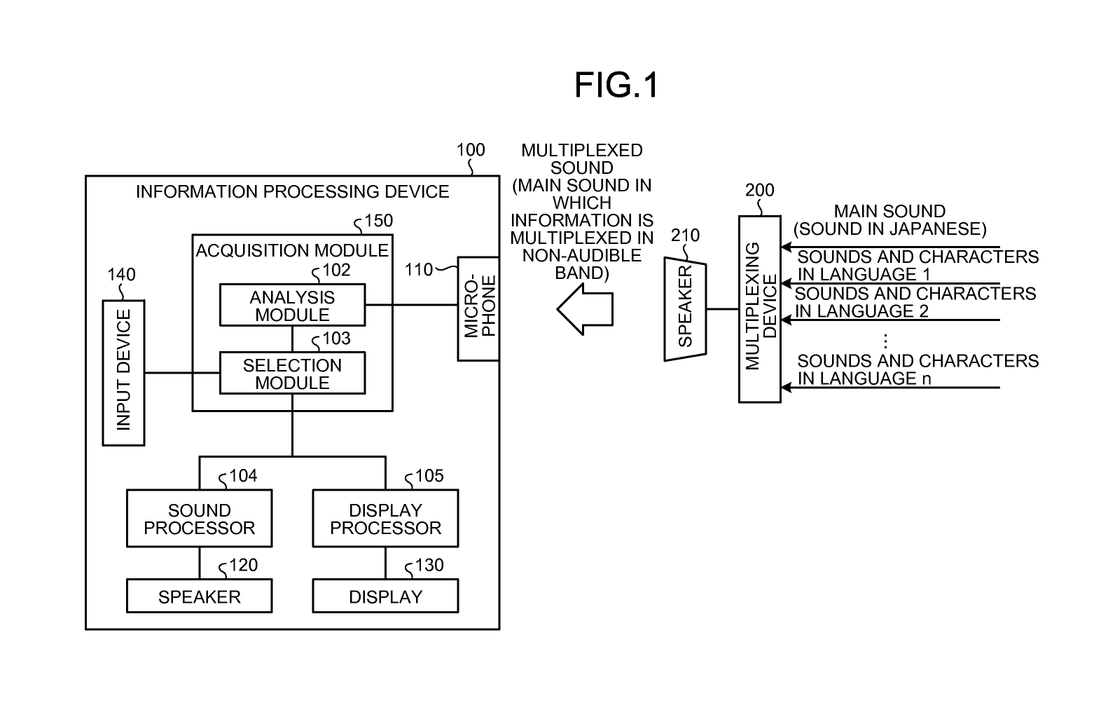

FIG. 1 is a view illustrating a configuration of an information processing system according to a first embodiment. The information processing system in the present embodiment comprises a multiplexing device 200 and an information processing device 100. The multiplexing device 200 multiplexes, for example, main sound that is sound in Japanese and sub data that is sounds and characters of languages 1 to n other than Japanese to output the multiplexed sound from a speaker 210. The main sound may be any sound signals transmitted through an audible band. The sub data may be any signals (sound signals or non sound signals) transmitted through a non-audible band.

In the present embodiment, the main sound of the sound in Japanese is sound wave having frequencies in the audible band. The multiplexing device 200 generates sounds obtained by multiplexing main sound in the audible band and sub data that include sounds and characters of languages 1 to n in the non-audible band as digital data, converts the sounds into multiplexed analog sounds, and outputs the multiplexed sound converted from the speaker 210.

The multiplexed sound output from the speaker 210 is composed of the main sound in the audible band and the sub data in the non-audible band that are multiplexed and hence, only the main sound (sound in Japanese) in the audible band is audible to human ears.

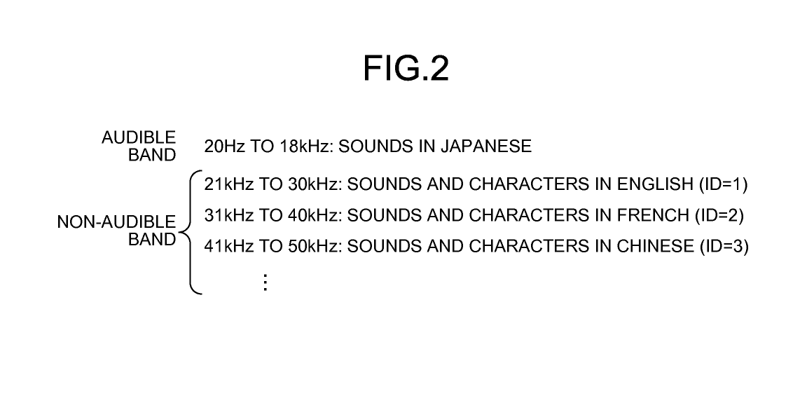

FIG. 2 is a view illustrating an example of multiplexed sound in the first embodiment. In FIG. 2, the audible band is set to a frequency band in the range from 20 Hz to 18 kHz, and the non-audible band is set to a frequency band of 21 kHz or higher. The first embodiment is explained by taking an example such that the upper limit of the audible band is set to 18 kHz, the lower limit of the non-audible band is set to 21 kHz, and the margin thereof is set to 2 kHz. However, the first embodiment is not limited to this example, each of the upper limit of the audible band and the lower limit of the non-audible band may be set to a frequency in the vicinity of 10 kHz or higher, and the margin can be changed properly according to the design thereof.

As illustrated in FIG. 2, the multiplexed sound in the present embodiment is composed of, in addition to sounds in Japanese in the audible band, sounds and characters in English in a non-audible band in the range from 21 to 30 kHz, sounds and characters in French in a non-audible band in the range from 31 to 40 kHz, and sounds and characters in Chinese in a non-audible band in the range from 41 to 50 kHz that are multiplexed as sub data. Furthermore, illustrated in FIG. 2, sub data of each language also includes an ID for identifying each language.

The information processing device 100 collects multiplexed sound output from the speaker 210, analyzes the multiplexed sound collected, and extracts and outputs sub data in a non-audible band.

Referring back to FIG. 1, the information processing device 100 is explained in detail. The information processing device 100 in the present embodiment mainly comprises, as illustrated in FIG. 1, a microphone 110, an acquisition module 150, a sound processor 104, a display processor 105, an input device 140, a speaker 120, and a display 130.

The microphone 110 functions as a sound collecting device, and collects multiplexed sound output from the speaker 210.

The input device 140 is a device that makes a user perform input operations and, for example, corresponds to a keyboard, a mouse, or the like. In the present embodiment, when the microphone 110 collects multiplexed sound, the input device 140 receives a user's determination whether listening to sounds and viewing characters other than main sound are performed. Furthermore, the input device 140 receives the selection of sub data desired by the user.

The acquisition module 150 acquires sub data in a non-audible band from the multiplexed sound collected. To be more specific, the acquisition module 150 comprises, as illustrated in FIG. 1, an analysis module 102 and a selection module 103. The analysis module 102 converts (performs A-D conversion of) multiplexed analog sounds collected by the microphone 110 into multiplexed digital sound data. Furthermore, the analysis module 102 analyzes the multiplexed digital sound data to acquire one piece of sub data or a plurality of pieces of sub data in a non-audible band. In the present embodiment, the analysis module 102 acquires, as illustrated in FIG. 2, each of sounds and characters in English, sounds and characters in French, and sounds and characters in Chinese as the sub data.

The selection module 103 selects and extracts sub data whose selection is received by the input device 140 out of the one piece of sub data or the pieces of sub data in the non-audible band acquired by the analysis module 102. In the present embodiment, the selection module 103 selects sub data of the language type selected by a user out of sounds and characters in English, sounds and characters in French, and sounds and characters in Chinese. An ID is allocated to each language type in advance, and the selection module 103 selects sub data having an ID corresponding to the ID of the language type selected by the user out of the sub data acquired by the analysis module 102 thus selecting the sub data of the language type selected by the user.

Here, in the present embodiment, sub data are identified by the ID and selected. However, the present embodiment is not limited to the above-mentioned method for selecting sub data.

The display processor 105 controls the display of various kinds of screens, characters, or the like with respect to the display 130. In the present embodiment, the display processor 105 displays character data of the sub data selected in the selection module 103 on the display 130.

The sound processor 104 converts (performs D-A conversion of) a digital sound signal into an analog sound signal to output the analog sound signal to the speaker 120. In the present embodiment, digital sound data that is the sub data selected in the selection module 103 are converted into analog sounds and the analog sounds are output to the speaker 120.

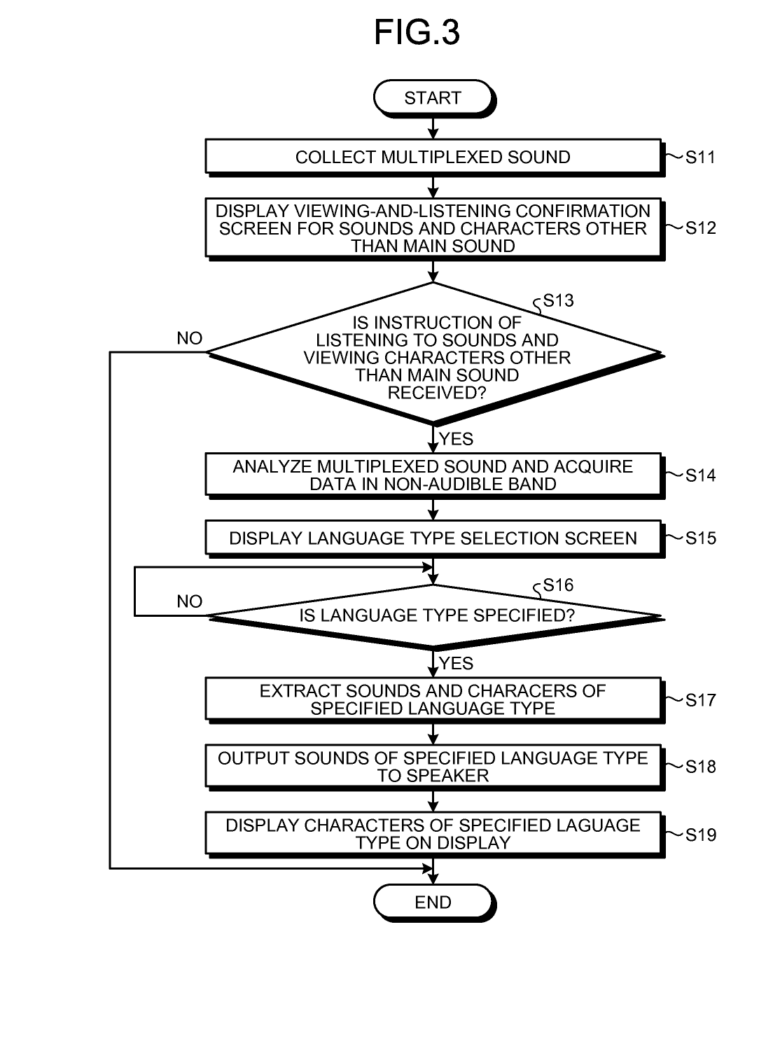

Next, output processing performed by the information processing device 100 in the present embodiment that is configured as mentioned above is explained. FIG. 3 is a flowchart illustrating procedures of sub data output processing in the first embodiment.

First of all, the microphone 110 collects multiplexed sound in which main sound in an audible band and sub data in a non-audible band are multiplexed (S11). The display processor 105 displays a viewing-and-listening confirmation screen for sounds and characters other than the main sound on the display 130 (S12).

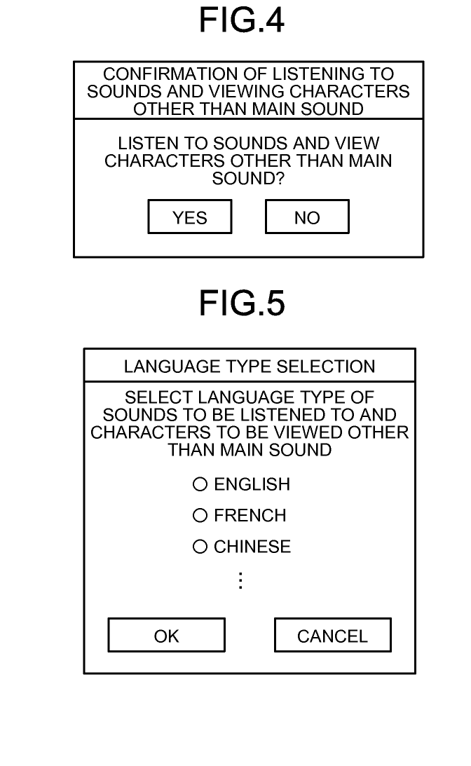

The viewing-and-listening confirmation screen for sounds and characters other than the main sound is a screen for making a user specify whether the user performs listening to sounds and viewing characters other than the main sound. FIG. 4 is a view illustrating one example of the viewing-and-listening confirmation screen for sounds and characters other than the main sound. In the example illustrated in FIG. 4 of the viewing-and-listening confirmation screen for sounds and characters other than the main sound, a message is displayed for querying whether the user performs listening to sounds and viewing characters other than the main sound. In response to this message, if the user depresses a “Yes” button on the input device 140, an instruction is provided to the effect that the user performs listening to sounds and viewing characters other than the main sound.

In the example of the viewing-and-listening confirmation screen for sounds and characters other than the main sound, the user depresses a “No” button on the input device 140 and hence, an instruction is provided to the effect that the user does not perform listening to sounds and viewing characters other than the main sound.

With reference to FIG. 3 again, the analysis module 102 determines whether the instruction to the effect that a user performs listening to sounds and viewing characters other than the main sound is received from the user (S13). Furthermore, the analysis module 102 finishes processing when receiving an instruction to the effect that the user does not perform listening to sounds and viewing characters other than the main sound (No at S13).

When the analysis module 102 receives the instruction to the effect that the user performs listening to sounds and viewing characters other than the main sound (Yes at S13), the analysis module 102 A-D-converts the multiplexed sound collected at S11, analyzes the multiplexed sound data A-D-converted, and acquires one piece of sub data or a plurality of pieces of sub data in a non-audible band (S14). In the present embodiment, as illustrated in FIG. 2, sounds and characters of a plurality of languages are acquired as sub data.

Next, the display processor 105 displays a language type selection screen on the display 130 (S15). The selection module 103 is in a state of waiting the reception of a language type specification from a user (No at S16).

Here, the language type selection screen is a screen on which a user selects sub data including sounds and characters of a desired language out of sounds and characters of a plurality of languages as sub data. FIG. 5 is a view illustrating one example of the language type selection screen. In the example of the language type selection screen in FIG. 5, a user selects a desired language type out of sounds and characters in English, sounds and characters in French, and sounds and characters in Chinese. That is, in the language type selection screen in FIG. 5, if a check box arranged on the left side of each language type is ticked by using the input device 140, the language corresponding to the check box ticked is specified by the user, and the selection module 103 receives the specification of the language.

With reference to FIG. 3 again, when the selection module 103 receives the specification of the language type (Yes at S16), the selection module 103 extracts the sounds and characters of the language of the sub data having an ID corresponding to the ID of the language type specified (S17). The sound processor 104 D-A-converts the sounds of the language of the sub data extracted at S17 into analog sounds to output the analog sounds to the speaker 120 (S18). Next, the display processor 105 displays the characters of the language of the sub data extracted at S17 on the display 130 (S19).

Here, one example of the mode of utilizing the present embodiment is explained. For example, a case where a user listens to speech sounds in a presentation room is considered. It is assumed that in speech sounds of a presentation, main sound in an audible band are constituted in English, and sounds and characters obtained by translating the contents of the speech from English to French are multiplexed in a non-audible band. Furthermore, it is assumed that for a user who listens to the speech, a notebook PC is available as the information processing device in the present embodiment. In the presentation room, a user capable of understanding English listens to only the main sound of the speech sound output from a speaker in the presentation room as usual without using the notebook PC. On the other hand, a user who wants to view and listen to the contents of the presentation in French obtains sounds and characters in French that are multiplexed in a non-audible band by using the above-mentioned notebook PC or the like in which the speech sounds are collected from the microphone 110 of the notebook PC and analyzed and hence, the user can view and listen to the contents of the speech in French.

For example, a case of listening to announcements on a platform of a station is considered. It is assumed that in announcement sounds, main sound in an audible band is constituted in Japanese, and sounds in English are multiplexed in a non-audible band as sub data. Furthermore, it is assumed that a user carries a smart phone functions as the information processing device in the present embodiment. When the user cannot understand Japanese, although the user hears Japanese announcements as main sound, the announcement speech sounds are collected and analyzed by the smart phone, and sounds in English multiplexed in a non-audible band are output and hence, the user can listen to announcement sounds translated from Japanese into English.

In this manner, in the present embodiment, sub data such as sounds and characters of a language different from the language of the main sound are multiplexed in a non-audible band and output, the multiplexed sound output is collected and analyzed, and the sub data such as sounds and characters of a language different from the language of the main sound multiplexed in a non-audible band are extracted and output when the sub data are used. Due to such a configuration, according to the present embodiment, the main sound and sub data such as sounds or the like of the other languages are included in the multiplexed sound and can be simultaneously used without disturbing a user, and the limitation of the number of sounds capable of being listened simultaneously can be eliminated.

According to the present embodiment, the sub data are multiplexed in a non-audible band and hence, the sounds other than the main sound are not audible for a user who uses no information processing device thus avoiding an influence on the user.

The present embodiment utilizes the feature of directivity of sounds without using an electromagnetic wave band thus transmitting the contents of information to be transmitted in the range of the reach of usual main sound and, at the same time, providing information required only in the above-mentioned range as sub data.

In the present embodiment, sub data multiplexed in a non-audible band can be acquired and hence, even when main sound is indiscernible or even when a user fails to hear the main sound, the sub data is recorded, so that contents same as the main sound can be recorded as a log.

In addition, in the present embodiment, sub data in a non-audible band are output, when it is requested by a user and hence, when main sound alone is insufficient for the user, the sub data can be flexibly used.

### Second Embodiment

In the first embodiment, a user selects a desired language type from sub data of one or a plurality of languages that are multiplexed in a non-audible band to listen to sounds and view characters obtained from the sub data analyzed. In a second embodiment, sub data are selected and output that satisfies predetermined conditions out of sub data of one or a plurality of languages that are multiplexed in a non-audible band.

The configurations of an information processing system and the information processing device 100 in the second embodiment are the same as those of the first embodiment. Furthermore, the configuration of multiplexed sound is also the same as those of the first embodiment.

The selection module 103 in the present embodiment selects sub data such as sounds and characters of a specific language out of sub data, which are acquired by the analysis module 102, such as sounds and characters of one or a plurality of languages based on predetermined conditions. The predetermined conditions correspond, for example, to a condition such that sub data in a specific frequency band such as the first frequency band of a non-audible band are selected. Furthermore, when sub data such as sounds and characters of a single language are multiplexed in a non-audible band, the selection module 103 selects the sounds and characters of the language. Here, the predetermined conditions may be arbitrarily set and are not limited to the above-mentioned example.

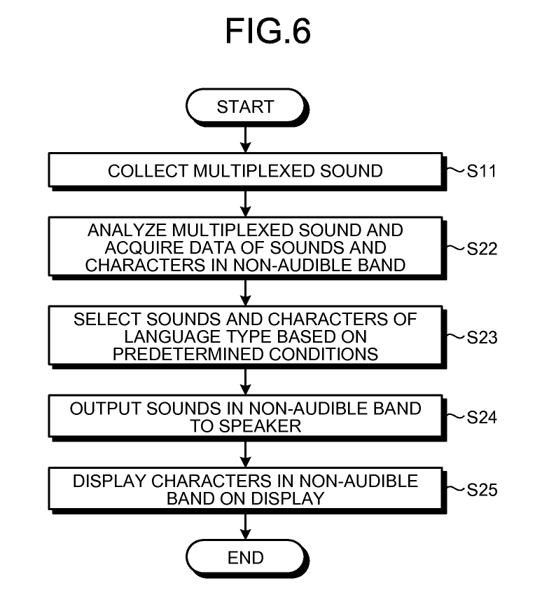

Next, output processing of sub data by the information processing device 100 configured as above in the present embodiment is explained. FIG. 6 is a flowchart illustrating procedures of sub data output processing in the second embodiment.

First of all, the microphone 110 collects, in the same manner as in the first embodiment, multiplexed sound in which sub data in a non-audible band are multiplexed (S11).

Next, the analysis module 102 A-D-converts the multiplexed sound collected at S11, analyzes the multiplexed sound data A-D-converted, and acquires one piece of sub data or a plurality of pieces of sub data in a non-audible band (S22). In the present embodiment also, in the same manner as in the first embodiment, sounds and characters of a plurality of languages are acquired as the sub data.

Next, the selection module 103 selects and extracts sub data of sounds and characters of a specific language (sub data embedded in the first frequency in the range from 21 kHz to 30 kHz, for example) out of sub data of sounds and characters acquired at S22 based on predetermined conditions (S23).

The sound processor 104 D-A-converts sound data of the language of the sub data extracted at S23 into analog sounds to output the analog sounds to the speaker 120 (S24). Next, the display processor 105 displays characters of the language of the sub data extracted at S23 on the display 130 (S25).

In this manner, in the present embodiment, sub data that satisfies predetermined conditions are selected out of sub data of one or a plurality of languages that are multiplexed in a non-audible band and the sub data are output thus achieving advantageous effects similar to the case of the first embodiment and also reducing time and effort of selecting sub data by a user.

### Third Embodiment

In the first and the second embodiments, main sound is embedded in an audible band and sub data such as sounds and characters of the other languages are multiplexed in a non-audible band. In a third embodiment, the main sound is not embedded in the audible band and multiplexed sound in which the sub data are multiplexed in the non-audible band is collected and analyzed, and the sub data in the non-audible band are output.

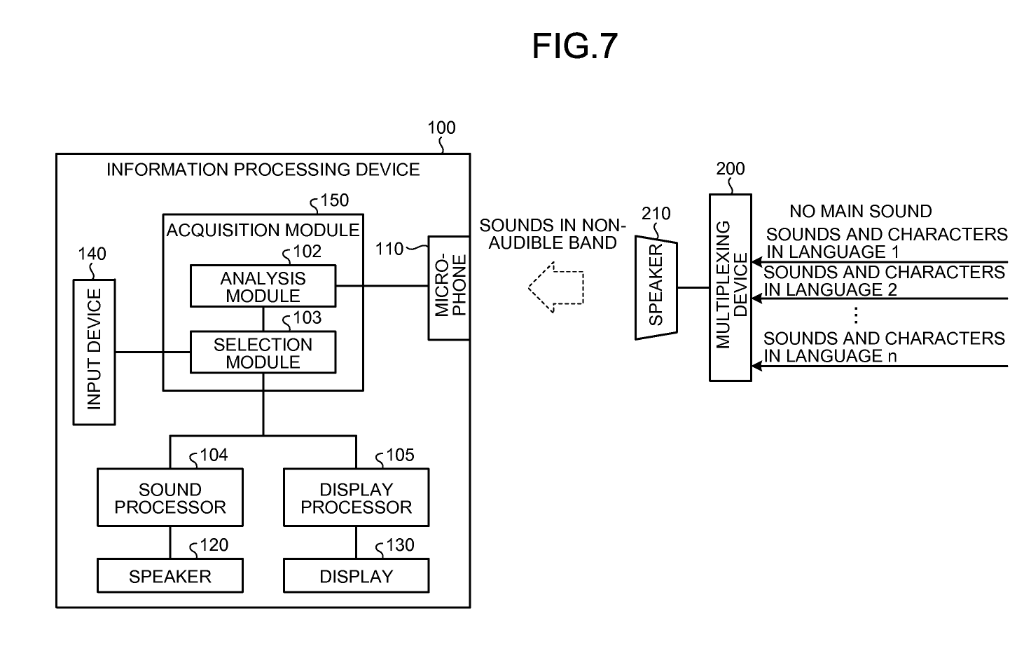

FIG. 7 is a view illustrating a configuration of an information processing system in the third embodiment. The information processing system in the present embodiment comprises the multiplexing device 200 and the information processing device 100. The configurations of the multiplexing device 200 and the information processing device 100 in the present embodiment are the same as those of the first or the second embodiment.

The multiplexing device 200 multiplexes, for example, sub data such as sounds and characters of languages 1 to n in a non-audible band without embedding main sound in an audible band to output the multiplexed sound from the speaker 210. Accordingly, for a user, sounds are not audible from the speaker 210.

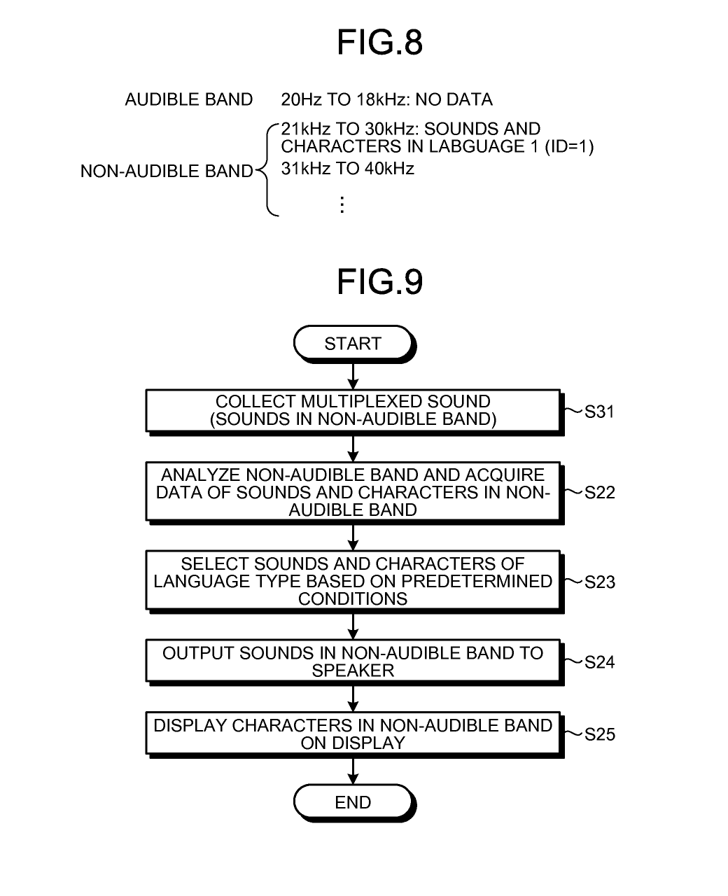

FIG. 8 is a view illustrating an example of multiplexed sound in the third embodiment. In FIG. 8 also, in the same manner as in the first embodiment, the audible band is set to a frequency band of 20 Hz to 18 kHz, and the non-audible band is set to a frequency band of 21 kHz or higher.

As illustrated in FIG. 8, with respect to the multiplexed sound in the present embodiment, no sound is embedded in the audible band, and no audible sounds are involved. Sounds and characters of the language 1 are multiplexed in the non-audible band of a frequency in the range from 21 to 30 kHz with an ID as sub data to constitute multiplexed sound.

Next, output processing of sub data by the information processing device 100 configured as above in the present embodiment is explained. FIG. 9 is a flowchart illustrating procedures of sub data output processing in the third embodiment.

First of all, the microphone 110 collects multiplexed sound in which sub data in a non-audible band are multiplexed (S31). Here, the multiplexed sound is not audible for a user. Thereafter, analysis processing, selection processing, and output processing of the sub data in the non-audible band (S22 to S25) are performed in the same manner as in the first or the second embodiment. FIG. 9 illustrates the respective processes as processes identical with the case of the second embodiment.

In this manner, in the present embodiment, no sound is embedded in an audible band and multiplexed sound in which sub data are multiplexed in a non-audible band is collected and analyzed, and the sub data in the non-audible band are output. Accordingly, for example, sound waves of such multiplexed sound that is not audible for a human are output at a specific place and hence, only when a user is within the output range of the sound waves, the user can obtain sub data that is multiplexed in the non-audible band in advance and inherent in the specific place by using the information processing device 100. Due to such a configuration, according to the present embodiment, desired sub data can be provided only to a user who is at a specific place and uses the information processing device 100 without being noticed by others.

Modification

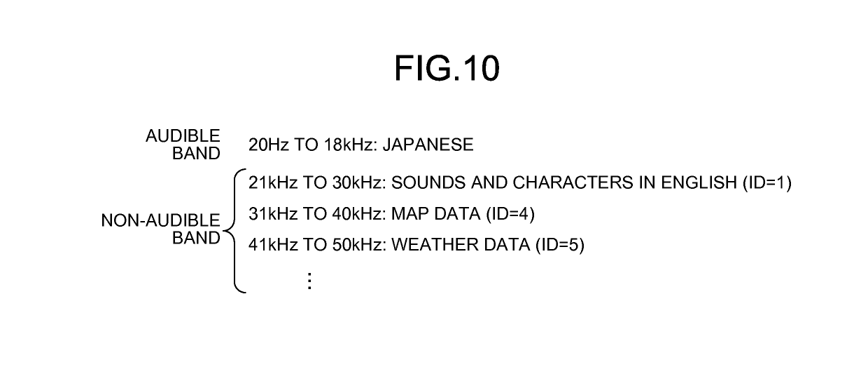

In the first to the third embodiments, sounds and characters of a language different from that of main sound are multiplexed in a non-audible band as sub data. However, sub data is not limited to this example. For example, the sub data may be configured such that weather data or map data that are inherent in a specific place are multiplexed in a non-audible band. FIG. 10 is a view illustrating one example of a multiplexed sound structure according to the modification. In the example illustrated in FIG. 10, map data is multiplexed in a frequency in the range from 31 kHz to 40 kHz in a non-audible band and weather data is multiplexed in a frequency in the range from 41 kHz to 50 kHz in the non-audible band with main sound in Japanese in an audible band.

In this manner, various kinds of data are embedded in a non-audible band as sub data thus achieving the use of a large variety of sub data without disturbing a user.

### Fourth Embodiment

In a fourth embodiment, sub data is selected and output out of a plurality of pieces of sub data multiplexed in a non-audible band based on list data multiplexed in the same non-audible band.

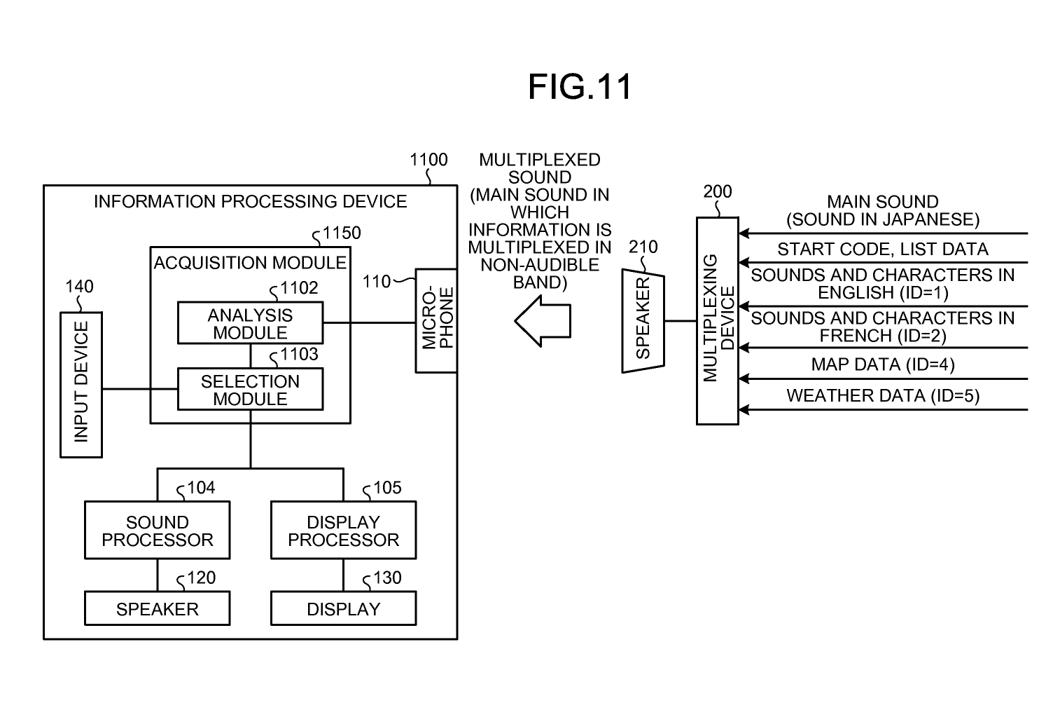

FIG. 11 is a view illustrating a configuration of an information processing system according to the fourth embodiment. The information processing system in the fourth embodiment comprises the multiplexing device 200 and an information processing device 1100. The configuration of the multiplexing device 200 is the same as those of each of the first to the third embodiments.

In multiplexed sound in the present embodiment, sounds in Japanese are multiplexed in an audible band as main sound, and a start code, list data, sounds and characters of a language different from that of the main sound, and data other than a language are multiplexed in a non-audible band as sub data.

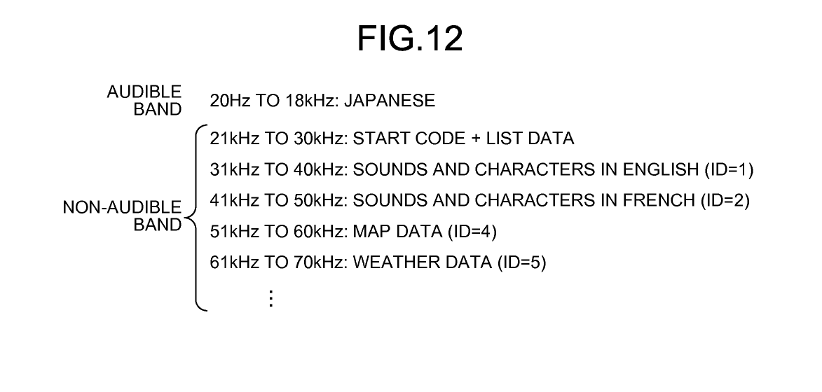

FIG. 12 is a view illustrating an example of multiplexed sound in the fourth embodiment. In FIG. 12, in the same manner as in the first embodiment, the audible band is set to a frequency band in the range from 20 Hz to 18 kHz, and the non-audible band is set to a frequency band of 21 kHz or higher.

As illustrated in FIG. 12, in multiplexed sound in the present embodiment, the sounds in Japanese are included in an audible band as main sound. The start code and successively list data are embedded in a non-audible band of a frequency in the range from 21 to 30 kHz of the multiplexed sound. Furthermore, in the multiplexed sound, sounds and characters in English, sounds and characters in French, map data, and weather data are embedded with IDs and multiplexed in a non-audible band of a frequency in the range from 31 kHz to 40 kHz, in a non-audible band of a frequency in the range from 41 kHz to 50 kHz, in a non-audible band of a frequency in the range from 51 kHz to 60 kHz, and in a non-audible band of a frequency in the range from 61 kHz to 70 kHz respectively.

Here, the start code is a code indicating a specific waveform when the start code is embedded and analyzed as sub data in the non-audible band, and is information indicating that there exist list data in successive several seconds. Furthermore, the list data are data in which the IDs of the sub data embedded in the non-audible band are registered in order of the acquisition of the ID in advance. For example, the ID is registered in order of “3, 4, 1, 2, . . . ”. A selection module 1103 described later acquires sub data each corresponding to an ID in order of IDs registered in the list data.

The information processing device 1100 mainly comprises, as illustrated in FIG. 11, the microphone 110, an acquisition module 1150, the sound processor 104, the display processor 105, the input device 140, the speaker 120, and the display 130. Here, functions of the microphone 110, the sound processor 104, the display processor 105, the input device 140, the speaker 120, and the display 130 are the same as those of the first embodiment.

The acquisition module 1150 comprises an analysis module 1102, and the selection module 1103. The analysis module 1102 analyzes, in the same manner as in the first embodiment, a non-audible band of multiplexed sound collected by the microphone 110, and further acquires list data for successive several seconds after the start code when a specific waveform indicated by the start code in the first frequency in the range from 21 kHz to 30 kHz in the non-audible band is detected.

The selection module 1103 sequentially reads out IDs registered in the list data acquired in the analysis module 1102 to select sequentially the sub data corresponding to each ID read out. Due to such a configuration, the sub data in the non-audible band are output in order of the ID registered in the list data.

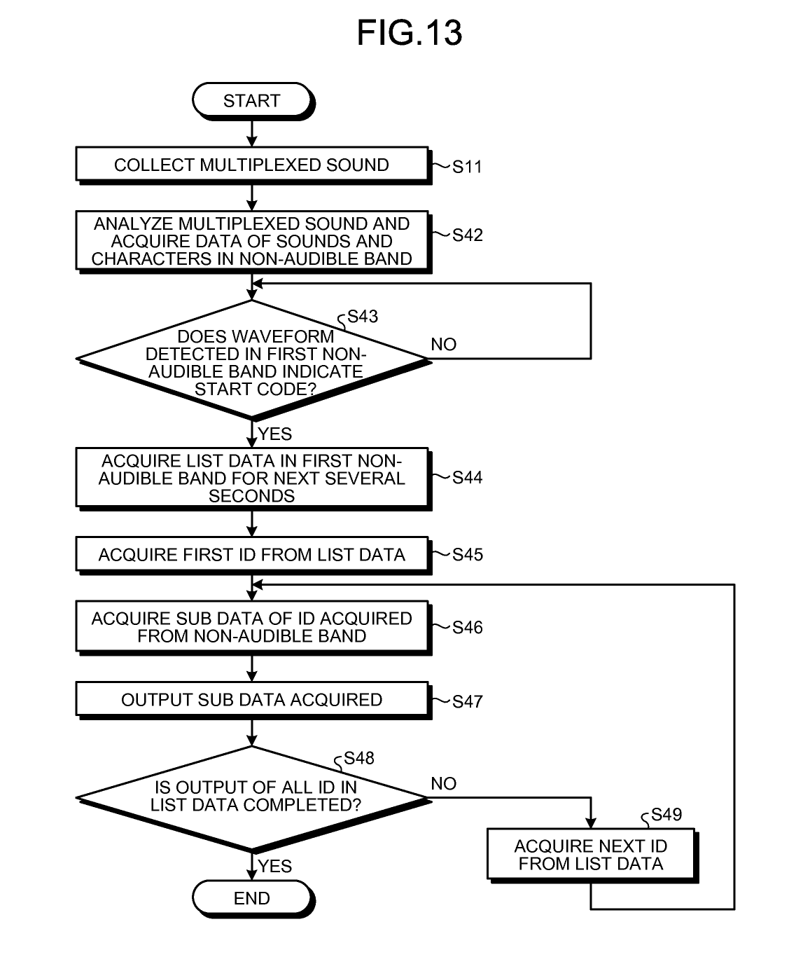

Next, output processing of sub data by the information processing device 1100 configured as above in the present embodiment is explained. FIG. 13 is a flowchart illustrating procedures of sub data output processing in the fourth embodiment.

First, the microphone 110 collects, in the same manner as in the first embodiment, multiplexed sound in which sub data in a non-audible band are multiplexed (S11).

Next, the analysis module 1102 acquires one piece of sub data or a plurality of pieces of sub data in the non-audible band (S42). Furthermore, the analysis module 1102 determines whether a specific waveform indicating a start code has been detected in the first frequency band in the range from 21 kHz to 30 kHz in the non-audible band (S43). When the specific waveform indicating the start code is not detected (No at S43), the determination whether the specific waveform is detected is repeated.

When the specific waveform indicating the start code is detected (Yes at S43), the analysis module 1102 acquires data input for several seconds after the start code in the first frequency band in the range from 21 kHz to 30 kHz as list data (S44).

Next, the selection module 1103 acquires the first ID registered in the list data (S45). Furthermore, the selection module 1103 acquires the sub data of an ID corresponding to the ID acquired from the non-audible band (S46). Then, the sub data acquired are output (S47). To be more specific, when the sub data acquired are sounds, the sound processor 104 outputs the sub data to the speaker 120. When the sub data acquired are characters, map data, or weather data, the display processor 105 displays the sub data on the display 130.

The selection module 1103 determines whether the above-mentioned processes of S46 and S47 have been completed with respect to all IDs registered in the list data (S48). When the processes of S46 and S47 are not completed with respect to the all IDs registered in the list data (No at S48), the selection module 1103 acquires the next ID registered in the list data (S49), and the processes of S46 and S47 are repeatedly performed.

When the processes of S46 and S47 are completed with respect to the all IDs registered in the list data (Yes at S48), the processing is finished.

In this manner, in the present embodiment, sub data is selected from a plurality of pieces of sub data multiplexed in a non-audible band based on the list data multiplexed in the same non-audible band thus using a variety of sub data comprehensively.

Here, in the present embodiment, the list data are embedded in the non-audible band of multiplexed sound after the start code, and the IDs of sub data embedded in the non-audible band are multi-registered in the list data in order of the acquisition of the ID. However, a plurality of IDs may be embedded after the start code of the non-audible band in order of the acquisition of the ID without using the list data.

Here, in the first to the fourth embodiments, sub data are multiplexed in a non-audible band divided into a frequency band in the range from 21 to 30 kHz, a frequency band in the range from 31 to 40 kHz, and a frequency band in the range from 41 to 50 kHz. However, the manner of dividing the non-audible band into a plurality of frequency bands is not limited to this example.

In the first to the fourth embodiments, the explanation is made by using an example that multiplexes both sounds and characters in a non-audible band as sub data. However, only the sounds or only the characters may be multiplexed in a non-audible band. Furthermore, the sounds and characters may be multiplexed in a non-audible band as sub data for each language in a pattern such as only the sounds, only the characters, or both of the sounds and characters. In addition, sub data other than a language is not limited to map data or weather data, and any information may be multiplexed in a non-audible band as sub data.

Each of the information processing devices 100 and 1100 in the above-mentioned embodiments comprises a controller such as a CPU, a storage module such as a read only memory (ROM) or a RAM, an external storage device such as an HDD device or a CD drive device, a display apparatus such as a display device, and an input device such as a keyboard or a mouse, and constituted of hardware using a general computer.

The sub data output program executed in the information processing device 100 or 1100 in the embodiments above is recorded and provided as a computer program product in a computer-readable recording medium such as a compact disc read only memory (CD-ROM), a flexible disk (FD), a compact disc recordable (CD-R), and a digital versatile disc (DVD), as an installable or executable file.

The sub data output program executed in the information processing device 100 or 1100 in the embodiments above may be stored in a computer connected to a network such as the Internet and provided as a computer program product by being downloaded via the network. Furthermore, the sub data output program executed in the information processing device 100 or 1100 in the embodiments above may be provided as a computer program product or distributed via a network such as the Internet.

In addition, the sub data output program executed in the information processing device 100 or 1100 in the embodiments above may be embedded and provided as a computer program product in a ROM, for example.

The sub data output program executed in the information processing devices 100 and 1100 in the embodiments above is constituted of modules comprising the above-mentioned respective modules (the analysis module 102 or 1102, the selection module 103 or 1103, the sound processor 104, and the display processor 105). As actual hardware, a central processing unit (CPU) reads out the sub data output program from the above-mentioned storage medium to execute the program, and thus the above-mentioned respective modules are loaded on a main memory, and the analysis module 102 or 1102, the selection module 103 or 1103, the sound processor 104, and the display processor 105 are generated on the main memory.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a receiver configured to receive a signal of multiplexed sound comprising data of main sound and sub data, the data of main sound being multiplexed in an audible frequency band, the sub data being multiplexed in a non-audible frequency band, the multiplexed sound being output by an audio speaker of another device and being collected by a microphone of the electronic apparatus; and
a processor configured to acquire the sub data from the signal of the multiplexed sound, and to output the sub data.

2. The electronic apparatus of claim 1, wherein a plurality of pieces of sub data are multiplexed in the non-audible frequency band, the electronic apparatus further comprising:
an input module configured to receive the specification of a first piece of sub data out of the pieces of sub data, wherein
the processor is configured to output the first piece of sub data acquired.

3. The electronic apparatus of claim 1, wherein a plurality of pieces of sub data are multiplexed in the non-audible frequency band, the electronic apparatus further comprising:
a selection module configured to select any piece of sub data based on predetermined conditions out of the pieces of sub data acquired.

4. The electronic apparatus of claim 1, wherein
the multiplexed sound comprises start information and one piece or a plurality of pieces of identification information specified for identifying the sub data in advance in the non-audible frequency band, and
the processor is configured to sequentially acquire, when the start information in the non-audible frequency band is detected, sub data corresponding to one or more pieces of the identification information specified.

5. The electronic apparatus of claim 1, wherein the signal of the multiplexed sound comprises the data of the main sound in an audible frequency band.

6. The electronic apparatus of claim 1, wherein the signal of the multiplexed sound comprises no sound in an audible frequency band.

7. The electronic apparatus of claim 1, wherein
the main sound is sound of a first language, and
the sub data comprises sound and character of a language other than the first language.

8. The electronic apparatus of claim 7, wherein the processor comprises a sound output module configured to output the sound and a display module configured to display the character.

9. The electronic apparatus of claim 1, wherein the sub data comprises map data or weather data.

10. A method for outputting data, the method comprising:
receiving a signal of multiplexed sound comprising data of main sound and sub data, the data of main sound being multiplexed in an audible frequency band, the sub data being multiplexed in a non-audible frequency band, the multiplexed sound being output by an audio speaker of another device and being collected by a microphone of an electronic apparatus;
acquiring the sub data from the signal of the multiplexed sound; and
outputting the sub data.

11. A computer program product having a non-transitory computer readable medium including programmed instructions, wherein the instructions, when executed by a computer, cause the computer to perform:
receiving a signal of multiplexed sound comprising data of main sound and sub data, the data of main sound being multiplexed in an audible frequency band, the sub data being multiplexed in a non-audible frequency band, the multiplexed sound being output by an audio speaker of another device and being collected by a microphone of an electronic apparatus;
acquiring the sub data from the signal of the multiplexed sound; and
outputting the sub data.
